(19) United States
(12) Patent Application Publication
(10) Pub. No.: US 2006/0121233 A1
(43) Pub. Date: Jun. 8, 2006

(54) Optical recording media and method of fabricating the same

(75) Inventors: Chia-Sheng Lin, Kaohsiung County (TW); Hung-Chuan Cheng, Taoyuan County (TW)

Correspondence Address: BIRCH STEWART KOLASCH & BIRCH, PO BOX 747, FALLS CHURCH, VA, 22040-0747, US

(73) Assignee: Daxon Technology Inc.

(21) Appl. No.: 11/290,576

(22) Filed: Dec. 1, 2005

(30) Foreign Application Priority Data
Dec. 3, 2004 (TW) 93137342

(51) Int. Cl. B32B 3/02

(52) U.S. Cl. 428/64.4

(57) ABSTRACT

An optical recording medium comprises a substrate, a recording layer overlying the substrate, and a phosphorus layer overlying the recording layer, wherein the phosphorus layer can be excited to illuminate by irradiation of a laser beam.

### BACKGROUND

The invention relates to an optical recording media and method of fabricating the same, and in particular to an optical recording disk and method of fabricating the same.

Due to requirement of large size in file size of digital video, capacity of current compact disks recordable CD-R is not enough. Digital versatile disks DVD are new generation of optical recording media suitable for large size digital video data.

In compact recordable disks CD-R and digital versatile disks DVD manufacturing process, substrates are formed by injection molding with stampers carved with grooves. FIG. 1 shows a recording one time digital versatile disk. As shown in FIG. 1, a recording layer 102 is formed on the substrate 100 using a spin coating method. The thickness of the recording layer 102 is about 50 nm-200 nm. A reflective layer 104 is formed on the recording layer 102 by a sputtering method. An adhesion layer 106 is coated on the recording layer 102. A top plate 101 is bonded to the reflective layer 104 through the adhesion layer 106. The recording layer 102 is formed by spin coating dyes on the substrate uniformly, in which the quantity of the dyes in the grooves and on the lands are tuned to control optical path difference (Ld) therebetween. Signals of the disk can be controlled according to Ld. Consequently, spin coating of the dye is an important factor in a recording media manufacturing process and can affect the quality of the recording media.

CD and DVD have two sides. Typically, one side is for data reading or writing, and the other side is for printing. UV printing, Flexo printing or screen printing are the major printing methods. For those optical recording media printed by the known printing methods, however, the integrity of data burned thereon cannot be verified from the printing side. In addition, burning patterns and conditions of an optical recording media formed by known methods cannot be viewed under dark environment.

### SUMMARY

An embodiment of the invention provides an optical recording medium, comprises a substrate, a recording layer overlying the substrate, and a phosphorus layer, wherein the phosphorus layer can be excited to illuminate by irradiation of a laser beam.

An embodiment of the invention provides a method for causing an optical recording medium to self-illuminate. An optical recording medium, comprising a substrate, a recording layer disposed overlying the substrate, a top plate, and a phosphorus layer overlying the top plate or interposed between the top plate and the recording layer is provided. The phosphorus layer comprises phosphorus material capable of producing phosphorescence when excited. The recording layer is irradiated by a laser, wherein the phosphorus material in the phosphorus layer is excited to illuminate by the laser.

An embodiment of the invention provides a method for forming an optical recording medium. A substrate and a top plate are provided. A recording layer is formed overlying the substrate. A phosphorus layer is formed overlying the top plate or between the recording layer and the top plate.

### BRIEF DESCRIPTION OF THE DRAWINGS

The invention can be more fully understood by reading the subsequent detailed description and examples with references made to the accompanying drawings, wherein:

FIG. 1 shows a recording one time digital versatile disk.

FIG. 2 shows a recordable DVD in accordance with a phosphorus layer of an embodiment of the invention.

FIG. 3 shows a recordable DVD in accordance with a phosphorus layer of another embodiment of the invention.

FIG. 4 shows a curve of wave length versus light absorption.

FIG. 5 shows a structure of a CDR.

FIG. 6 shows a structure of a DVD-RW.

FIG. 7 shows a structure of a CD-RW.

FIG. 8 shows phosphorus material in a phosphorus layer excited by a laser beam.

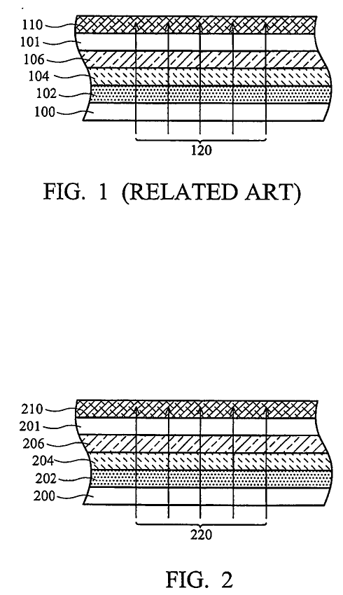

### DETAILED DESCRIPTION OF THE INVENTION

Phosphorus materials can illuminate for an extended duration after excited. In an embodiment of the invention, a phosphorus layer comprising phosphorus material is provided. The phosphorus material in the phosphorus layer can be excited to illuminate after being irradiating by a laser beam, in which the phosphorus material is transformed from a static state to an excited state. Application of the phosphorus layer in the optical recording mediums is described in the following. The invention, however, is not limited thereto, and the phosphorus layer can be used in any optical recording medium.

FIG. 2 shows a recordable DVD in accordance with the phosphorus layer of an embodiment of the invention. As shown in FIG. 2, a substrate 200 is provided. The substrate 200 comprises polymer, and preferably comprises polycarbonate or PMMA. In a preferred embodiment of the invention, the substrate 200 has high transmittance, larger than of about 90%, such that the laser beam has adequate energy to excite a phosphorus layer to illuminate thereafter.

Next, a recording layer 202 is formed on the substrate 200. The recording layer 202 can comprise organic dye, and is preferably formed by spin coating. In a preferred embodiment, the recording layer 202 has a thickness of about 40 nm-70 nm. A reflective layer 204 is formed on the recording layer 202 by, for example sputtering method. The reflective layer 204 comprises materials with a higher reflecting coefficient, and preferably comprises Ag, Al, Au or combinations with rare metals. In an embodiment of the invention, the reflective layer 204 has transmittance of about 40%˜70% to not affect laser excitation of a phosphorus layer. Thickness of the reflective layer 204 is determined according to its material. For example, the thickness of the reflective layer 204 is preferably about 25 nm˜40 nm when Ag is used.

An adhesion layer 206 is formed on the reflective layer 204 by, for example spin coating. A top plate 201 is bonded to the reflective layer 204 through the adhesion layer 206. The top plate 201 also preferably has transmittance lager than 90% to not affect laser exciting a phosphorus layer. In general, the top plate 201 has a thickness of about 0.5˜0.8 mm. Preferably, thickness of the top plate 201 is about 0.6 mm.

Next, a phosphorus layer 210 is formed on the top plate 201. The phosphorus layer 210 can be formed by spin coating phosphorus materials combined with polymer. In addition, the phosphorus layer 210 can also be formed by screen printing with printing ink combined with phosphorus materials.

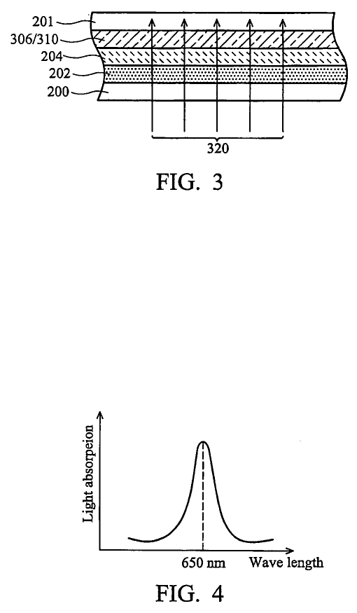

FIG. 3 shows a recordable DVD in accordance with a phosphorus layer of another embodiment of the invention. Referring to FIG. 3, the adhesion layer 306 interposed between the top plate 201 and the reflective layer 204 can be combined with phosphorus materials to act as phosphorus layer 310. In an embodiment, the composition of phosphorus materials in the phosphorus layer corresponds to the power and wavelength of an optical writing head of a DVD/CD burner. In addition, the phosphorus materials also correspond to the position of the phosphorus layer 310 in the optical recording medium. For example, referring to FIG. 4, the phosphorus material preferably has better excitation effect at a wavelength of about 650 nm, when the optical writing head irradiates a laser of wave length of 650 nm.

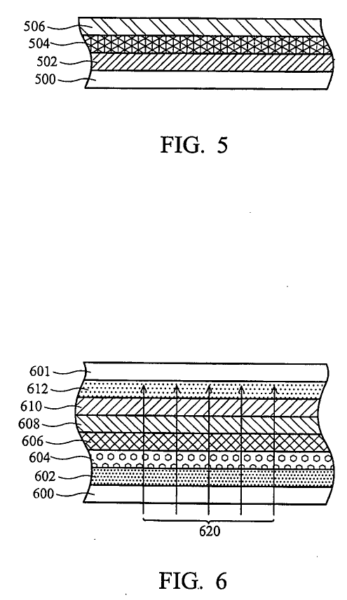

The invention, however, is not limited to recordable DVD. The phosphorus layer and the method for exciting a phosphorus layer to illuminate by a laser of an optical writing head can be used in any optical recording medium. FIG. 5 shows a structure of a recordable compact disk CD-R. A CD-R comprises a substrate 500, a recording layer 502, a reflective layer 504 and a protective layer 506 in order. In an embodiment, a phosphorus layer can be disposed on the protective layer 506. In another embodiment, the phosphorus layer can be interposed between the reflective layer 504 and protective layer 506.

The phosphorus layer can also be used in rewritable optical recording medium. FIG. 6 shows a structure of a DVD-RW. As shown in FIG. 6, the DVD-RW comprises a substrate 600, a first dielectric layer 602, a recording layer 604, a second dielectric layer 606, a reflective layer 608, a protective film 610, an adhesion layer 612 and a top plate 601. In an embodiment, the phosphorus layer comprising phosphorus material can be interposed between any two layers of the described DVD-RW. In another embodiment, the phosphorus layer comprises ink and phosphorus material coated on the top plate 601. The composition and corresponding thickness of the described layers meets the requirement of the phosphorus layer excitation causing illumination when irradiated by a laser beam of an optical recording head.

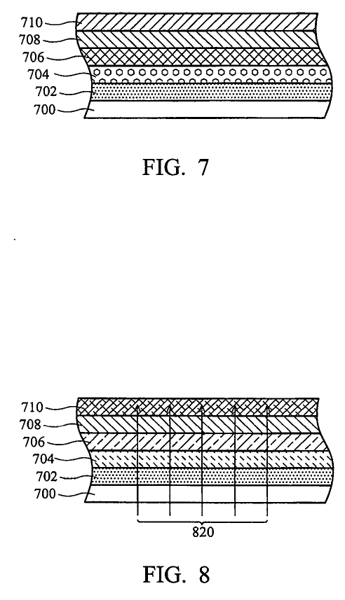

The phosphorus layer can also be used in CD-RW. FIG. 7 shows a structure of a CD-RW. Referring to FIG. 7, the CD-RW comprises a substrate 700, a first dielectric layer 702, a recording layer 704, a second dielectric layer 706, a reflective layer 708 and a protective layer 710 in order. In an embodiment, the phosphorus layer comprising phosphorus material can be interposed between any two layers of the described CD-RW. In another embodiment, the phosphorus layer comprising ink and phosphorus material is coated on the protective layer 710. As shown in FIG. 8, the phosphorus material in the phosphorus layer 710 can be excited to illuminate by laser beam 820 of an optical writing head of a drive when writing data. Consequently, the optical recording media with the phosphorus layer can be beautified, and can be identified its burning patterns under dark environment.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical recording medium, comprising:
a substrate;
a recording layer overlying the substrate; and
a phosphorus layer overlying the recording layer, wherein the phosphorus layer can be excited to illuminate by irradiation of a laser beam.

2. The optical recording medium as claimed in claim 1, further comprising a reflective layer disposed overlying the recording layer, an adhesion layer disposed overlying the reflective layer and a top plate disposed overlying the adhesion layer.

3. The optical recording medium as claimed in claim 2, wherein the phosphorus layer is interposed between the top plate and the reflective layer.

4. The optical recording medium as claimed in claim 2, wherein the phosphorus layer is disposed overlying the top plate.

5. The optical recording medium as claimed in claim 4, wherein the phosphorus layer comprises a combination of ink and a phosphorus material, and the phosphorus layer is formed on the substrate by screen printing.

6. The optical recording medium as claimed in claim 1, further comprising a reflective layer disposed overlying the recording layer, and a protective layer disposed overlying the reflective layer.

7. The optical recording medium as claimed in claim 6, wherein the phosphorus layer is interposed between the protective layer and the reflective layer.

8. The optical recording medium as claimed in claim 6, wherein the phosphorus layer is disposed overlying the protective layer.

9. An optical recording medium, comprising:
a substrate;
a first dielectric layer overlying the substrate;
a recording layer overlying the first dielectric layer;
a second dielectric layer overlying the recording layer;
a reflective layer overlying the second dielectric layer;
a top plate overlying the reflective layer; and
a phosphorus layer interposed between any two layers thereof.

10. The optical recording medium as claimed in claim 9, wherein the thickness of the first dielectric layer is thin enough for the phosphorus layer to be excited by a laser beam of an optical reading and writing apparatus.

11. The optical recording medium as claimed in claim 9, wherein the thickness of the second dielectric layer is thin enough for the phosphorus layer to be excited by a laser beam of an optical reading and writing apparatus.

12. The optical recording medium as claimed in claim 9, wherein the thickness of the reflective layer is thin enough for the phosphorus layer to be excited by a laser beam of an optical reading and writing apparatus.

13. The optical recording medium as claimed in claim 9, wherein the thickness of the recording layer is thin enough for the phosphorus layer to be excited by a laser beam of an optical reading and writing apparatus.

14. A method for causing an optical recording medium to illuminate, comprising:
providing an optical recording medium, comprising a substrate, a recording layer disposed overlying the substrate, a top plate, and a phosphorus layer overlying the top plate or interposed between any two layers thereof, the phosphorus layer comprises phosphorus materials producing phosphorescence when excited; and
irradiating the recording layer by a laser, wherein the phosphorus material in the phosphorus layer is excited to illuminate by the laser.

15. The method for causing an optical recording medium to illuminate as claimed in claim 14, wherein the source of the laser is originated from an optical reading or writing head of a drive.

16. A method for forming an optical recording medium, comprising:
providing a substrate and a top plate;
forming a recording layer overlying the substrate; and
forming a phosphorus layer overlying the top plate or between any two layers thereof.

17. The method for forming an optical recording medium as claimed in claim 16, wherein the phosphorus layer is formed with a combination of ink and phosphorus materials by screen printing on the top plate.

18. The method for forming an optical recording medium as claimed in claim 16, further comprising:
forming a first dielectric layer between the recording layer and the substrate;
forming a second dielectric layer overlying the recording layer;
forming a reflective layer overlying the second dielectric layer;
forming an adhesion layer overlying the reflective layer; and
bonding the reflective layer and the top plate through the adhesion layer.

19. The method for forming an optical recording medium as claimed in claim 18, wherein the phosphorus layer is formed between the first dielectric layer and the substrate.

20. The method for forming an optical recording medium as claimed in claim 18, wherein the phosphorus layer is formed between the first dielectric layer and the recording layer.
